(19) United States
(12) Patent Application Publication
(10) Pub. No.: US 2006/0038971 A1
(43) Pub. Date: Feb. 23, 2006

(54) DUAL RETICLE DEVICE AND ASSEMBLING METHOD THEREOF

(76) Inventors: Shang-Yung Liang, Taichung (TW); Chia-Chun Chang, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,192

(22) Filed: Dec. 21, 2004

(30) Foreign Application Priority Data
Aug. 18, 2004 (TW) 93124768

(51) Int. Cl. G03B 27/62

(52) U.S. Cl. 355/75

(57) ABSTRACT

A dual reticle device comprising a ring structure, a first reticle and a second reticle is provided. Four positioning grooves parallel to the axis of the ring structure are formed on the external side surface of the ring. The first reticle and the second reticle are disposed on a first ring end-surface and a second ring end-surface of the ring structure respectively. In the process of assembling the dual reticle device, the positioning grooves position the first and the second reticle on the first and second ring end-surface of the ring structure. Therefore, the first reticle and the second reticle coincide with each other in the axial direction of the ring structure so that the dual reticle device can serve as a tool for improving the accuracy of aiming at a target object set at a distance.

### CROSS-REFERENCE TO RELATED APPLICATION

This application claims the priority benefit of Taiwan application serial no. 93124768, filed on Aug. 18, 2004.

### BACKGROUND OF THE INVENTION

1. Field of the Invention

The present invention relates to an aiming device and assembling method thereof. More particularly, the present invention relates to a dual reticle device and assembling method thereof.

2. Description of the Related Art

A conventional aiming device deploys a single reticle to align with a target. However, the alignment accuracy of an aiming device with a single reticle element is quite limited. For example, the finder of a rifle is normally disposed on a plane surface perpendicular to the gun barrel. In other words, the axis of the reticle module is in parallel to the gun barrel. Since the finder and the target may not lie on mutually parallel planes, there is no guarantee that the shooter can hit the target. Moreover, the amount of errors involved may not be perceptible to the human eye.

To increase the accuracy of aiming, an aiming device having two reticles has been developed. When the plane surface where the aiming device is resting on and the plane surface where the target object is resting on form an angle, the user can easily spot this through the finder because the reticles inside the finder will not coincide. Hence, the human eye can easily recognize any spatial misalignment between the target and the finder.

When an aiming device with dual reticle elements is set against a target, the reticles within the device must coincide with each other completely. Therefore, the degree of alignment between the two reticles is very important in the process of assembling the dual reticle device.

### SUMMARY OF THE INVENTION

Accordingly, the present invention is directed to provide a dual reticle device capable of improving the target-aiming accuracy of an aiming system.

The present invention is directed to provide a method of assembling a dual reticle device capable of reducing the number of assembling steps and increasing the overlapping accuracy of the reticle elements within the dual reticle device.

As embodied and broadly described herein, the invention provides a dual reticle device. The dual reticle device mainly comprises a ring structure, a first reticle and a second reticle. The ring structure has a first ring end-surface, a second ring end-surface and an outside surface. The outside surface connects the first ring end-surface and the second ring end-surface together. The axis of the ring structure is perpendicular to the first ring end-surface and the second ring end-surface. The first reticle is disposed on the first ring end-surface of the ring structure to partition the first ring end-surface into equal portions. Similarly, the second reticle is disposed on the second ring end-surface of the ring structure to partition the second ring end-surface into equal portions. In particular, the first reticle and the second reticle coincide with each other when looking in the axial direction of the ring structure.

According to the embodiment of the present invention, the outside surface of the ring structure has a pair of first positioning grooves and a pair of second positioning grooves. The first and second positioning grooves are parallel to the axis of the ring structure and set on the outside surface of the ring structure. Furthermore, the line joining the first positioning grooves on the first ring end-surface and the line joining the second positioning grooves on the first ring end-surface coincide with the first reticle. Similarly, the line joining the first positioning grooves on the second ring end-surface and the line joining the second positioning grooves on the second ring end-surface coincide with the second reticle.

According to the embodiment of the present invention, the first reticle comprises a first vertical line and a first horizontal line and the second reticle comprises a second vertical line and a second horizontal line. In one embodiment, the first vertical line of the first reticle and the second vertical line of the second reticle are fabricated from a single wire. Similarly, the first horizontal line of the first reticle and the second horizontal line of the second reticle are fabricated from a single wire.

According to one embodiment of the present invention, the ring structure is a circular ring structure, an elliptical ring structure or a polygonal ring structure, for example. The first reticle and the second reticle are fabricated using steel wires. In addition, the positioning grooves are V-cutting grooves.

The present invention also provides a method of assembling a dual reticle device comprising the following steps. First, a ring structure having a first and a second ring end-surface and an outside surface provided. The outside surface links up the first ring end-surface and the second ring end-surface. The axis of the ring structure is perpendicular to the first and the second ring end-surface. Thereafter, a pair of first positioning grooves and a pair of second positioning grooves are formed on the outside surface of the ring structure. The first and the second positioning grooves are parallel to the axis of the ring structure and set on the outside surface of the ring structure. A first reticle is set up on the first ring end-surface of the ring structure such that the line joining the first positioning grooves and the line joining the second positioning grooves coincide with the first reticle. Similarly, a second reticle is set up on the second ring end-surface of the ring structure such that the line joining the first positioning grooves and the line joining the second positioning grooves coincide with the second reticle. In particular, the first reticle and the second reticle coincide with each other when looking in the axial direction of the ring structure.

According to one embodiment of the present invention, the first reticle comprises a first vertical line and a first horizontal line. The process of mounting the first reticle on the first ring end-surface of the ring structure includes the following steps. First, the first vertical line is pulled across the first ring end-surface of the ring structure. The ends of the first vertical line are latched into the first positioning grooves and then the first vertical line is fastened to the first ring end-surface. Thereafter, the first horizontal line is pulled across the first ring end-surface of the ring structure. The ends of the first horizontal line are latched into the second positioning grooves and then the horizontal line is fastened to the first ring end-surface. The method of fastening the first vertical line and the first horizontal line to the first ring end-surface includes soldering or gluing.

The second reticle comprises a second vertical line and a second horizontal line. The process of mounting the second reticle on the second ring end-surface of the ring structure includes the following steps. First, the second vertical line is pulled across the second ring end-surface of the ring structure. The ends of the second vertical line are latched into the first positioning grooves and then the second vertical line is fastened to the second ring end-surface. Thereafter, the second horizontal line is pulled across the second ring end-surface of the ring structure. The ends of the second horizontal line are latched into the second positioning grooves and then the second horizontal line is fastened to the second ring end-surface. The method of fastening the second vertical line and the second horizontal line to the second ring end-surface includes soldering or gluing.

According to one embodiment of the present invention, the center of the first reticle coincides with the center of the ring structure after mounting the first reticle onto the first ring end-surface of the ring structure. Similarly, the center of the second reticle coincides with the center of the ring structure after mounting the second reticle onto the first ring end-surface of the ring structure.

The present invention also provides a second method of assembling a dual reticle device comprising the following steps. First, a ring structure having a first and a second ring end-surface and an outside surface provided. The outside surface links up the first ring end-surface and the second ring end-surface. The axis of the ring structure is perpendicular to the first and the second ring end-surface. Thereafter, a pair of first positioning grooves and a pair of second positioning grooves are formed on the outside surface of the ring structure. The first and the second positioning grooves are parallel to the axis of the ring structure and set on the outside surface of the ring structure. A first wire is wrapped around the ring structure such that a portion of the first wire is laid within one of the first positioning grooves while another portion of the first wire is laid within the other first positioning grooves. Therefore, a first vertical line is formed across the first ring end-surface and a second vertical line is formed across the second ring end-surface of the ring structure. The first vertical line and the second vertical line coincide with each other when looking in the axial direction of the ring structure. Thereafter, the first wire is fastened to the ring structure.

A second wire is wrapped around the ring structure such that a portion of the second wire is laid within one of the second positioning grooves while another portion of the second wire is laid within the other second positioning grooves. Therefore, a first horizontal line is formed across the first ring end-surface and a second horizontal line is formed across the second ring end-surface of the ring structure. The first horizontal line and the second horizontal line coincide with each other when looking in the axial direction of the ring structure. Thereafter, the second wire is fastened to the ring structure.

According to one embodiment of the present invention, the method of fastening the first wire and/or the second wire to the ring structure includes soldering or gluing the two ends of the wire to the first ring end-surface and the second ring end-surface.

According to one embodiment of the present invention, the crossing point between the first vertical line and the first horizontal line and the crossing point between the second vertical line and the second horizontal line both coincide with the center of the ring structure.

In the present invention, a relatively simple process is used to form the positioning grooves for positioning the two reticle elements on the ring structure such that the reticles coincide with the axis of the ring. Hence, the assembled dual reticle device can have higher alignment accuracy.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a dual reticle device according to one preferred embodiment of the present invention.

FIG. 1B is a side view looking from the top of a first ring end-surface of the dual reticle device shown in FIG. 1A.

FIG. 2 is a schematic cross-sectional view of a positioning groove according to another preferred embodiment of the present invention.

FIGS. 3A through 3C are perspective views showing the process of assembling a dual reticle device according to one preferred embodiment of the present invention.

FIGS. 4A and 4B are perspective views showing the process of assembling a dual reticle device according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, four positioning grooves are set up on a ring structure so that two reticles elements can be positioned on the ring structure. When the reticles are viewed in the axial direction of the ring structure, the reticles can be seen overlapping with each other. In the following, the ring structure and its assembling process are explained in more detail. However, it should be understood that the following description should by no means limit the scope of the present invention.

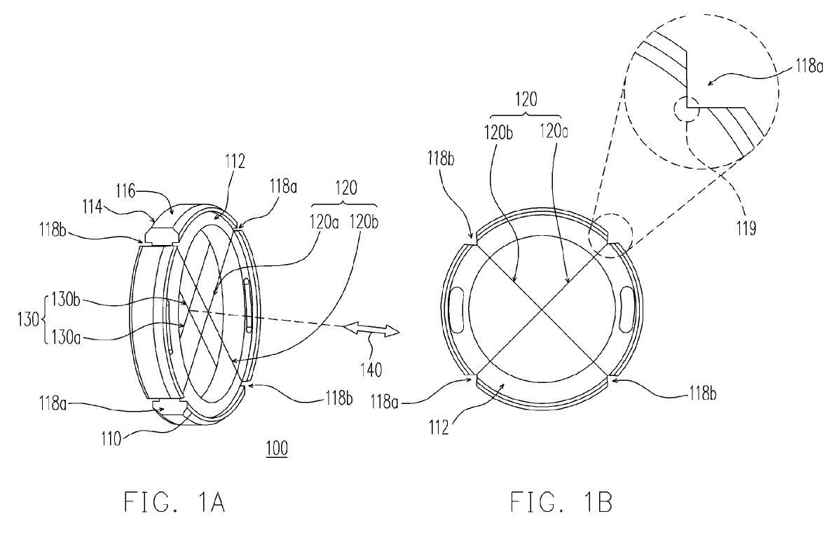

FIG. 1A is a perspective view of a dual reticle device according to one preferred embodiment of the present invention. FIG. 1B is a side view looking from the top of a first ring end-surface of the dual reticle device shown in FIG. 1A. As shown in FIGS. 1A and 1B, the dual reticle device 100 mainly comprises a ring structure 110, a first reticle 120 and a second reticle 130. The ring structure 110 has a circular shape, for example, but can be other shapes such as an elliptical or polygonal shape. The ring structure 110 has a first ring end-surface 112, a second ring end-surface 114 and an outside surface 116. The outside surface 116 joins the first ring end-surface 112 and the second ring end-surface 114 together. The axial direction 140 of the ring structure 110 is perpendicular to the first ring end-surface 112 and the second ring end-surface 114.

The first reticle 120 is set up on the first ring end-surface 112 of the ring structure 110 and partitions the first ring end-surface 112 equally. The second reticle 130 is set up on the second ring end-surface 114 of the ring structure 110 and partitions the second ring end-surface 114 equally. The first reticle 120 and the second reticle 130 are fabricated using steel wires, for example. It should be noted that the first reticle 120 of the present embodiment comprises a first vertical line 120a and a first horizontal line 120b and the second reticle 130 comprises a second vertical line 130a and a second horizontal line 130b. In other words, the first reticle 120 and the second reticle 130 of the present embodiment comprise two groups of perpendicularly crossed line segments. However, in other embodiments of the present invention, the first reticle 120 and the second reticle 130 can be fabricated from two groups of non-perpendicularly crossed line segments. In addition, the crossing point between the first vertical line 120a and the first horizontal line 120b and the crossing point between the second vertical line 130a and the second horizontal line 130b may coincide with the center of the ring structure 110.

In the present embodiment, the first vertical line 120a, the first horizontal line 120b, the second vertical line 130a and the second horizontal line 130b can be fabricated from four different wiring materials. In another embodiment, the first vertical line 120a and the second vertical line 130a are fabricated from one wiring material and the first horizontal line 120b and the second horizontal line 130b are fabricated from another wiring material.

It should be noted that the first reticle 120 and the second reticle 130 in the dual reticle device 100 coincide with each other (as shown in FIG. 1B) when viewed in the axial direction 140 of the ring structure 110. Therefore, the present invention is able to provide a dual reticle device for aiming at a target object with high accuracy.

In addition, the outside surface 116 has a pair of first positioning grooves 118a and a pair of second positioning grooves 118b for mounting the first reticle 120 and the second reticle 130 to the ring structure 110. The first positioning grooves 118a and the second positioning grooves 118b are parallel to the axial direction 140 of the ring structure 110 and set on the outside surface 116 of the ring structure 110. Furthermore, the line joining the two first positioning grooves 118a on the first ring end-surface 112 and the line joining the two second positioning grooves 118b on the first ring end-surface 112 coincide with the first reticle 120. Similarly, the line joining the two first positioning grooves 118a on the second ring end-surface 114 and the line joining the two second positioning grooves 118b on the second ring end-surface 114 coincide with the second reticle 130.

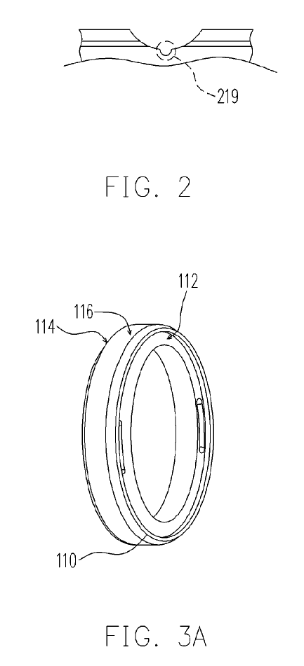

The first positioning grooves 118a and the second positioning grooves are V-cutting positioning grooves, for example. The V-cutting positioning grooves are designed to roll a wire down to a bottom area 119 (as shown in FIG. 1B). Obviously, the first positioning grooves 118a and the second positioning grooves 118b can have a cross-sectional configuration as shown in FIG. 1. In FIG. 2, the area 219 is a region for laying a wire. There is no set configuration for the first positioning grooves 118a and the second positioning grooves in the present invention. In fact, any type of positioning grooves on the ring structure 110 capable of positioning a wire can be used.

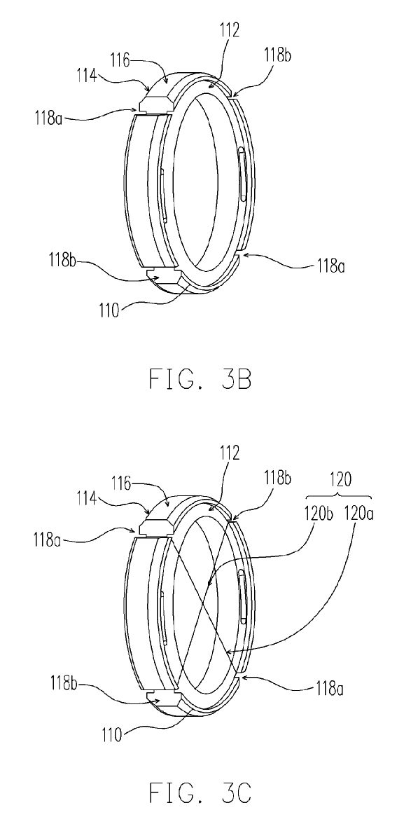

FIGS. 3A through 3C are perspective views showing the process of assembling a dual reticle device according to one preferred embodiment of the present invention. As shown in FIG. 3A, a ring structure 110 having a circular shape is provided. Clearly, the ring structure 110 can have some other shapes such as an elliptical or a polygonal shape. The ring structure 110 has a ring end-surface 112, a second ring end-surface 114 and an outside surface 116. The outside surface 116 joins the first ring end-surface 112 and the second ring end-surface 114 together. Furthermore, the ring structure 110 has an axis pointing in an axial direction 140 perpendicular to the first ring end-surface 112 and the second ring end-surface 114.

As shown in FIG. 3B, a pair of first positioning grooves 118a and a pair of second positioning grooves are formed on the outside surface 116 of the ring structure 110. The first positioning grooves 118a and the second positioning grooves 118b are parallel to the axial direction 140 and set on the outside surface 116 of the ring structure 110. In the present embodiment, the first positioning grooves 118a and the second positioning grooves 118b are V-cutting positioning grooves or positioning grooves having some other configuration (such as the one in FIG. 2). The V-cutting positioning grooves have a design that facilitates a wire down positioned inside the groove to roll down and rest in a bottom area 119 (as shown in FIG. 1B).

The first positioning grooves 118a and the second positioning grooves 118b are formed, for example, by machining the outside surface 116 of the ring structure 110 with a cutting tool. Because the actual dimension of the ring structure 110 is rather small, the outside surface 116 will not be too wide. Consequently, cutting out first positioning grooves 118a and second positioning grooves 118b in the outside surface 116 parallel to the axial direction 140 of the ring structure 110 so that the subsequently mounted reticles can coincide with the axial direction 140 will not be too difficult.

As shown in FIG. 3C, a first reticle 120 is mounted on the first ring end-surface 112 of the ring structure 110. In the present embodiment, the first reticle 120 comprises a first vertical line 120a and a first horizontal line 120b. To mount the first reticle 120, a first vertical line 120a is pulled across over the first ring end-surface 112 of the ring structure 110. The two ends of the first vertical line 120a are latched into the first positioning grooves 118a and then the first vertical line 120a is fastened to the first ring end-surface 112. Thereafter, a first horizontal line 120b is pulled across over the first ring end-surface 112 of the ring structure 110. The two ends of the first horizontal line 120a are latched into the second positioning grooves 118b and then the first horizontal line 120b is fastened to the first ring end-surface 112. The method of fastening the first vertical line 120a and the first horizontal line 120b to the first ring end-surface 112 includes, for example, soldering or gluing.

In another embodiment of the present invention, the mounting of the first reticle 120 may proceed in the following way. First, one end of the first vertical line 120a or the first horizontal line 120b is latched into a first positioning groove 118a or a second positioning groove 118b. Then, the first vertical line 120a or the first horizontal line 120b are fastened to the first ring end-surface 112 of the ring structure 110 by soldering or gluing. Thereafter, the other end of the first vertical line 120a or the first horizontal line 120b is latched into a second positioning groove 118a or a second positioning groove 118b. Finally, the second end of the first vertical line 120a or the first horizontal line 120b is fastened to the first ring end-surface 112 of the ring structure 110 by soldering or gluing. In other words, the present invention does not set up any restriction on whether the two ends of the first vertical line 120a or the first horizontal line 120b are fastened to the first ring end-surface 112 of the ring structure 110 simultaneously or not.

Thereafter, a second reticle 130 is mounted on the second ring end-surface 114 of the ring structure 110 to form a complete dual reticle device 100 as shown in FIG. 1A. Since the method of mounting the second reticle 130 is similar to the method of mounting the first reticle 120, detailed description is omitted.

It should be noted that the first positioning grooves 118a and the second positioning grooves 118b are parallel to the axial direction 140 of the ring structure 110. Furthermore, the position of the first reticle 120 and the second reticle 130 on the first ring end-surface 112 and the second ring end-surface 114 are determined by the first positioning grooves 118a and the second positioning grooves 118b. Hence, the first vertical line 120a of the first reticle 120 and the second vertical line 130a of the second reticle 130 coincide with each other in the axial direction 140 of the ring structure 110. Similarly, the first horizontal line 120b of the first reticle 120 and the second horizontal line 130b of the second reticle 130 coincide with each other in the axial direction of the ring structure 110 as shown in FIG. 1B.

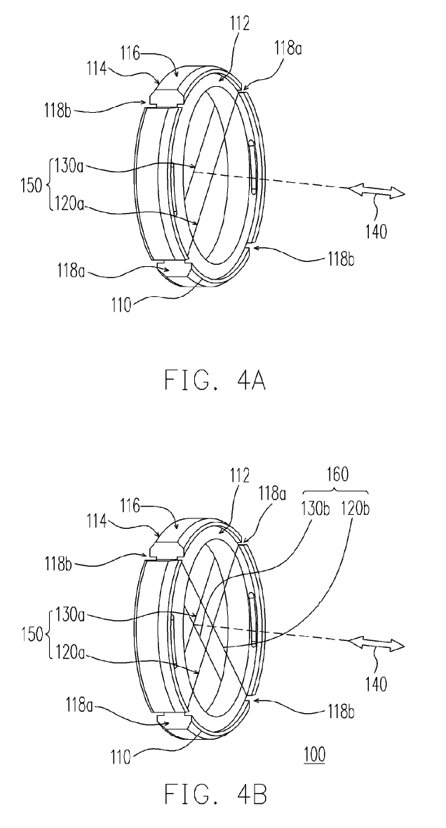

In another embodiment of the present invention, the first vertical line 120a of the first reticle 120 and the second vertical line 130a of the second reticle 130 can be fabricated from a single wire and the first horizontal line 120b of the first reticle 120 and the second horizontal line 130b of the second reticle 130 can be fabricated from a single wire. In this embodiment, the method of assembling the dual reticle device 100 after forming the ring structure 110 as shown in FIG. 3B is described using FIG. 4A. First, a first wire 150 is wrapped around the ring structure 110 so that a portion of the first wire 150 is disposed within a first positioning groove 118a and the two ends of the first wire 150 are disposed within another first positioning groove 118a. Therefore, a first vertical line 120a and a second vertical line 130a are formed on the first ring end-surface 112 and the second ring end-surface 114 of the ring structure 110. Thereafter, the two ends of the first wire 150 are fastened to the first ring end-surface 112 and the second ring end-surface 114 by soldering or gluing, for example.

It should be noted that the first vertical line 120a automatically coincides with the second vertical line 130a because the first positioning grooves 118a are parallel to the axial direction 140 and set on the outside surface 116 of the ring structure 110.

As shown in FIG. 4B, a second wire 160 is wrapped around the ring structure 110 so that a portion of the second wire 160 is disposed within a second positioning groove 118b and the two ends of the second wire 160 are disposed within another second positioning groove 118b. Therefore, a first horizontal line 120b and a second horizontal line 130b are formed on the first ring end-surface 112 and the second ring end-surface 114 of the ring structure 110. Here, the first horizontal line 120b automatically coincides with the second horizontal line 130b in the axial direction 140 of the ring structure 110. Hence, the first reticle 120 coincides with the second reticle 130 in the axial direction 140 of the ring structure 110. Thereafter, the two ends of the second wire 160 are fastened to the first ring end-surface 112 and the second ring end-surface 114 by soldering or gluing, for example.

In another embodiment of the present invention, one end of the first wire 150/second wire 160 can be latched into a first positioning groove 118a/second positioning groove 118b. Thereafter, this end is fastened to the first ring end-surface 112/second ring end-surface 114 of the ring structure 110. Then, the first wire 150/the second wire 160 is wrapped around the ring structure 110 so that a portion of the first wire 150/the second wire 160 is disposed within another first positioning groove 118a/second positioning groove 118b. The loose end of the first wire 150/the second wire 160 is latched into the first positioning groove 118a/the second positioning groove 118b having the fixed end of the first wire 150/the second wire 160. Finally, the loose end of the first wire 150/the second wire 160 is fastened to the second ring end-surface 114/the first ring end-surface 112 of the ring structure 110.

In summary, major advantages of the present invention includes:

1. Relatively simple processing method is used to form the positioning grooves on the ring structure so that the reticle elements are positioned on the ring structure with ease. Moreover, the reticles coincide with each other in the axial direction of the ring structure so that a dual reticle device with higher alignment accuracy is assembled.

2. The dual reticle device is fabricated using inexpensive material and simple processing steps. Hence, better dual reticle devices are obtained at a low production cost.

3. The reticles in the dual reticle device have higher overlapping accuracy so that a better target aiming capacity can be conferred to an aiming system having the device. For example, a rifle incorporating a dual reticle finder of the present invention is able to aim more accurately at a far away target.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dual reticle device, comprising:
a ring structure having a first ring end-surface, a second ring end-surface and an outside surface, wherein the outside surface joins the first ring end-surface and the second ring end-surface together, and the ring structure has a axis perpendicular to the first ring end-surface and the second ring end-surface;
a first reticle mounted on the first ring end-surface of the ring structure, wherein the first reticle partitions the first ring end-surface into equal portions; and
a second reticle mounted on the second ring end-surface of the ring structure, wherein the second reticle partitions the second ring end-surface into equal portions and the first reticle coincides with the second reticle in the axial direction of the ring structure.

2. The dual reticle device of claim 1, wherein the outside surface of the ring structure further comprises a pair of first positioning grooves and a pair of second positioning grooves such that the first positioning grooves and the second positioning grooves are parallel to the axial direction of the ring structure and set on the outside surface of the ring structure, furthermore, the line joining the first and second positioning grooves on the first ring end-surface coincide with the first reticle, and the line joining the first and second positioning grooves on the second ring end-surface coincide with the second reticle.

3. The dual reticle device of claim 1, wherein the first reticle comprises a first vertical line and a first horizontal line and the second reticle comprises a second vertical line and a second horizontal line.

4. The dual reticle device of claim 3, wherein the first vertical line of the first reticle and the second vertical line of the second reticle are fabricated using a single wire.

5. The dual reticle device of claim 4, wherein the first horizontal line of the first reticle and the second horizontal line of the second reticle are fabricated using a single wire.

6. The dual reticle device of claim 1, wherein the material constituting the first reticle comprises steel wire.

7. The dual reticle device of claim 1, wherein the material constituting the second reticle comprises steel wire.

8. The dual reticle device of claim 2, wherein the first positioning grooves and the second positioning grooves comprise V-cutting positioning grooves.

9. The dual reticle device of claim 1, wherein the shape of the ring in the ring structure comprises a circular shape, an elliptical shape or a polygonal shape.

10. A method of assembling a dual reticle device, comprising the steps of:
providing a ring structure having a first ring end-surface, a second ring end-surface and an outside surface, wherein the outside surface joins the first ring end-surface and the second ring end-surface together and the ring structure has an axis perpendicular to the first ring end-surface and the second ring end-surface;
forming a pair of first positioning grooves and a pair of second positioning grooves on the outside surface of the ring structure, wherein the first positioning grooves and the second positioning grooves are parallel to the axis of the ring structure and set on the outside surface;
mounting a first reticle on the first ring end-surface of the ring structure such that the line joining the first and second positioning grooves on the first ring end-surface coincide with the first reticle; and
mounting a second reticle on the second ring end-surface of the ring structure such that the line joining the first and second positioning grooves on the second ring end-surface coincide with the second reticle, wherein the first reticle coincides with the second reticle in the axial direction of the ring structure.

11. The assembling method of claim 10, wherein the first reticle comprises a first vertical wire and a first horizontal wire and the step of mounting the first reticle on the first ring end-surface comprises:
pulling the first vertical wire across the first ring end-surface of the ring structure such that the two ends of the first vertical wire fixed into the first positioning grooves respectively;
fastening the first vertical wire to the first ring end-surface;
pulling the first horizontal wire across the first ring end-surface of the ring structure such that the two ends of the first horizontal wire fixed into the second positioning grooves respectively;
fastening the first horizontal wire to the first ring end-surface so that the first vertical wire and the first horizontal wire together form the first reticle.

12. The assembling method of claim 11, wherein the step of fastening the first vertical wire and the first horizontal wire to the first ring end-surface comprises soldering or gluing.

13. The assembling method of claim 10, wherein the second reticle comprises a second vertical wire and a second horizontal wire and the step of mounting the second reticle on the second ring end-surface comprises:
pulling the second vertical wire across the second ring end-surface of the ring structure such that the two ends of the second vertical wire fixed into two of the positioning grooves respectively;
fastening the second vertical wire to the second ring end-surface;
pulling the first horizontal wire across the second ring end-surface of the ring structure such that the second horizontal wire fixed into the positioning points of the remaining positioning grooves respectively;
fastening the second horizontal wire to the second ring end-surface so that the second vertical wire and the second horizontal wire together form the second reticle.

14. The assembling method of claim 13, wherein the step of fastening the second vertical wire and the second horizontal wire to the second ring end-surface comprises soldering or gluing.

15. The assembling method of claim 10, wherein the center of the first reticle coincides with the center of the ring structure after mounting the first reticle on the first ring end-surface of the ring structure.

16. The assembling method of claim 15, wherein the center of the second reticle coincides with the center of the ring structure after mounting the second reticle on the second ring end-surface of the ring structure.

17. A method of assembling a dual reticle device, comprising the steps of:
providing a ring structure having a first ring end-surface, a second ring end-surface and an outside surface, wherein the outside surface joins the first ring end-surface and the second ring end-surface together and the ring structure has an axis perpendicular to the first ring end-surface and the second ring end-surface;
forming a pair of first positioning grooves and a pair of second positioning grooves on the outside surface of the ring structure, wherein the first positioning grooves and the second positioning grooves are parallel to the axis of the ring structure and set on the outside surface;
wrapping a first wire around the ring structure such that a portion of the first wire is disposed within one of the first positioning grooves and the two ends of the first wire is disposed within the other first positioning groove so that a first vertical wire and a second vertical wire are formed on the first ring end-surface and the second ring end-surface, wherein the first vertical wire and the second vertical wire coincide with each other in the axial direction of the ring structure;
fastening the first wire to the ring structure;
wrapping a second wire around the ring structure such that a portion of the second wire is disposed within one of the second positioning grooves and the two ends of the second wire is disposed within the other second positioning groove so that a first horizontal wire and a second horizontal wire are formed on the first ring end-surface and the second ring end-surface, wherein the first horizontal wire and the second horizontal wire coincide with each other in
the axial direction of the ring structure; and
fastening the second wire to the ring structure.

18. The assembling method of claim 17, wherein the step of fastening the first wire to the ring structure comprises soldering or gluing the two ends of the first wire to the first ring end-surface and the second ring end-surface of the ring structure respectively.

19. The assembling method of claim 17, wherein the step of fastening the second wire to the ring structure comprises soldering or gluing the two ends of the second wire to the first ring end-surface and the second ring end-surface of the ring structure respectively.

20. The assembling method of claim 17, wherein the crossing point between the first vertical wire and the first horizontal wire and the crossing point between the second vertical wire and the second horizontal wire coincide with the center of the ring structure.
